(19) United States
(12) Patent Application Publication
(10) Pub. No.: US 2010/0109602 A1
(43) Pub. Date: May 6, 2010

(54) CHARGING DEVICE AND METHOD OF OPERATING THE SAME

(75) Inventor: CHIA-YUAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/511,142

(22) Filed: Jul. 29, 2009

(30) Foreign Application Priority Data
Nov. 3, 2008 (CN) 200810305367.9

(51) Int. Cl. H02J 7/00

(52) U.S. Cl. 320/103; 320/107

(57) ABSTRACT

A charging device includes a MPU, a control module, an interface module, a charging and discharging module, and a power storage module. The MPU, the control module, the interface module, the charging and discharging module, and the power storage module are connected in series. The charging and discharging module is also connected to the MPU. The interface module is configured for connecting the charging device to at least one other charging device. The control module confirms if the charging device is to be a host or a client, and controls the MPU to activate the host charging device to charge a connected client charging device.

### BACKGROUND

1. Technical Field

The disclosure generally relates to charging devices, particularly to a charging device used in portable electronic devices and a method of operating the same.

2. Description of Related Art

With developments in wireless communication and information processing technologies, portable electronic devices such as mobile phones and personal digital assistants (PDAs) are now in widespread use, these portable electronic devices are usually connected to a computer or an external power supply to recharge the battery thereof. However, when the users of these portable electronic devices are outdoors, the computers and external power supplies are usually inaccessible, and these portable electronic devices may not be conveniently recharged. In addition, these portable electronic devices usually cannot connect to each other to share power if needed.

Therefore, there is room for improvement within the art.

### BRIEF DESCRIPTION OF THE DRAWINGS

Many aspects of the charging device and the method of operating the same can be better understood with reference to the following drawings. The components in the drawings are not necessarily drawn to scale, the emphasis instead being placed upon clearly illustrating the principles of the charging device and the method of operating the same.

FIG. 1 shows a block diagram of one charging device connected to another charging device to be recharged by the other device in accordance with an exemplary embodiment.

FIG. 2 shows a block diagram of the pins of two USB interfaces of the two charging devices shown in FIG. 1.

FIG. 3 shows a flow chart of a method of operating the charging device shown in FIG. 1.

FIG. 4 shows a block diagram of the charging device shown in FIG. 1 connected to other charging devices via a connecting device to be recharged by the other devices.

### DETAILED DESCRIPTION

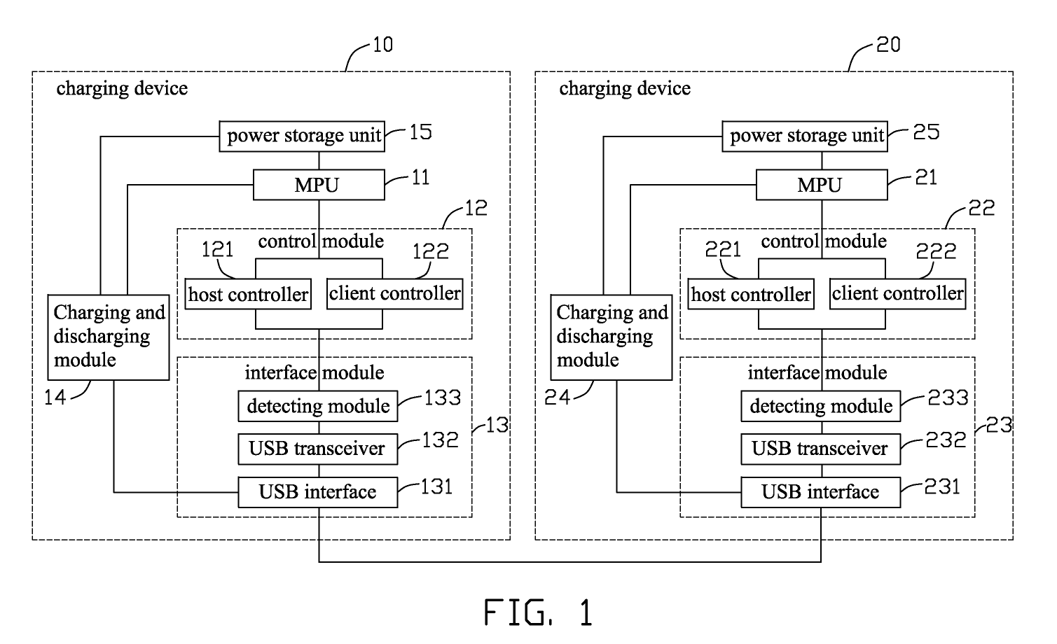

Referring to FIG. 1, a charging device 10 is used in portable electronic devices such as mobile phones, PDAs, or digital cameras. When two charging devices 10, 20, which are mounted in different portable electronic devices, are connected to each other, a user can set one of the two charging devices 10, 20 as a host, and the other charging device 10, 20 as a client. The host charging device charges the client charging device.

The charging device 10 includes a micro processor unit (MPU) 11, a control module 12, an interface module 13, a charging and discharging module 14, and a power storage module 15 electronically connected in series. The charging and discharging module 14 is also electronically connected to the MPU 11.

The MPU 11 is used to process inner data and application program of the charging device 10. The control module 12 is used to set the charging device 10 as a host or a client when the charging device 10 is connected to another charging device 10. The control module 12 includes a host controller 121 and a client controller 122. The host controller 121 and the client controller 122 can control the MPU 11 to activate charging or discharging programs respectively. When the charging device 10 is set as a host by a user, the host controller 121 is activated. When the charging device 10 is set as a client by a user, the client controller 122 is activated. Moreover, the MPU 11 can automatically judge if the charging device 10 is a host or a client when the charging device 10 is connected to another charging device 20 according to the voltage of the power storage module 15. For example, if the voltage of the power storage module 15 is higher than that of the power storage module 25 of another charging device 20 connected to charging device 10, the MPU 11 will judge the charging device 10 should be the host.

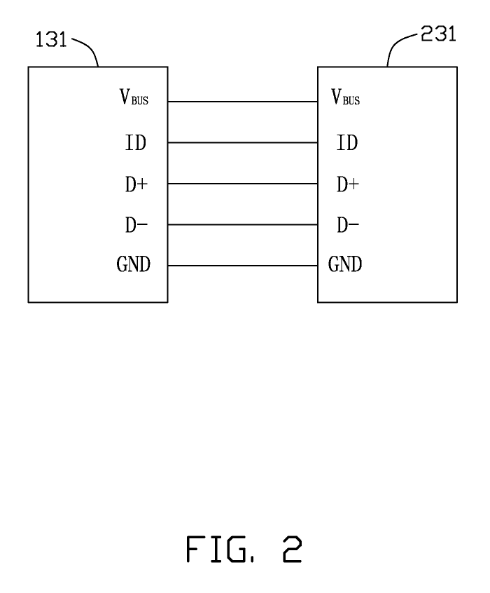

Referring to FIG. 2, the interface module 13 includes a universal serial bus (USB) interface 131, a USB transceiver 132, and a detecting module 133 electronically connected in series. The USB interface 131 is used for connecting the charging device 10 to another charging device 20. The USB interface 131 includes a V_{BUS} pin, a ID pin, a D+ pin, a D− pin, and a GND pin. The V_{BUS} pin is for inputting/outputting power. The ID pin is for confirming the charging device 10 is a host or a client. The D+ pin and the D− pin are for sending data. The GND pin is connected to ground. The USB transceiver 132 sends data between the USB interface 131 and the detecting module 133. The detecting module 133 obtains the ID pin information of another charging device 10 from the USB interface 131 to detect if the charging device 10 is a host or a client.

The charging and discharging module 14 is used to input power to the power storage module 15 or output power from the power storage module 15. Also, the charging and discharging module 14 is used to provide power to the MPU 11.

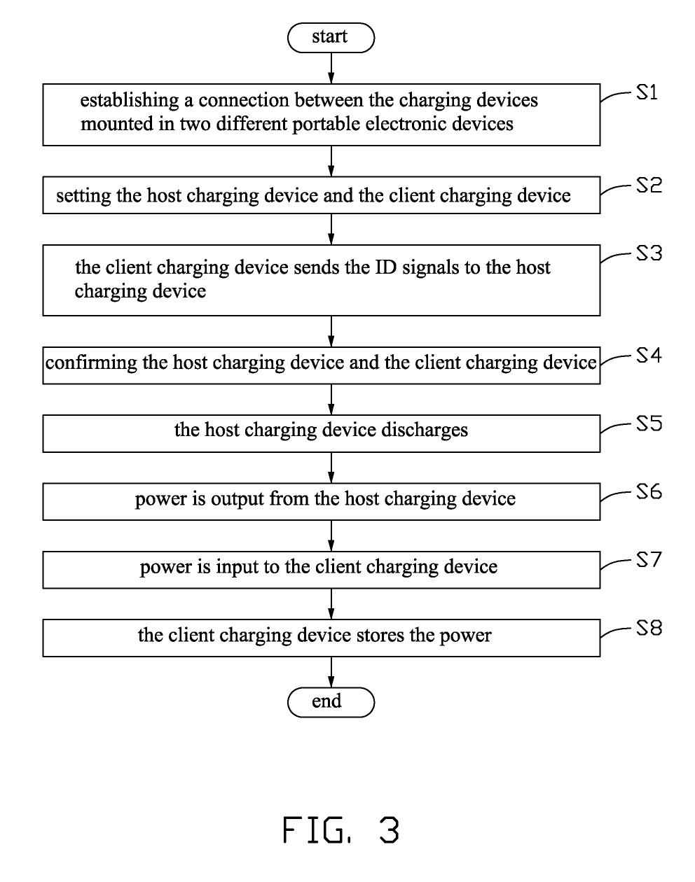

Referring to FIG. 3, the process of one charging device 10 charging another charging device 20 may include the following steps:

In step S1, establishing a connection between two charging devices 10, 20 mounted in two different portable electronic devices by means of connecting the USB interface 131 of the charging device 10 to the USB interface 231 of the charging device 20.

In step S2, setting one of the charging devices 10, 20 as a host, and the other one of the charging devices 10, 20 as a client.

In step S3, the client charging device sends its ID pin information to the host charging device.

In step S4, the host charging device confirms which charging device is the host charging device, and which charging device is the client charging device according to the ID pin information.

In step S5, the host charging device discharges. For example, if the charging device 10 is a host charging device, and the charging device 20 is a client charging device, the MPU 11 controls the power storage module 15 to discharge via the charging and discharging module 14.

In step S6, the power is output from the host charging device. As mentioned above, the power is output from the host charging device 10 via the USB interface 133.

In step S7, the power is input to the client charging device. The power is input to the client charging device 20 via the USB interface 233.

In step S8, the client charging device stores the power obtained from the host charging device.

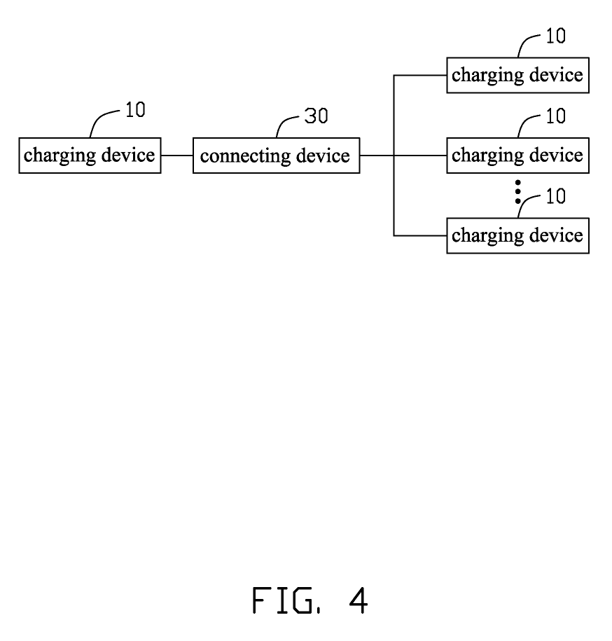

Referring to FIG. 4, during the process detailed above more than one charging device may be used at the same time. To illustrate, one charging device 10 set as host is connected to three charge devices 10 set as clients via a connecting device 30.

The charging devices 10 allow users to share power among their electronic devices when needed without the need of a computer or electrical outlet which is very convenient and efficient.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A charging device, comprising:
a MPU;
a control module;
an interface module;
a charging and discharging module; and
a power storage module, wherein the MPU, the control module, the interface module, the charging and discharging module, and the power storage module are connected in series, the charging and discharging module also connected to the MPU; the interface module is used to connect the charging device to at least one other charging device, the control module confirms if the charging device is to be a host or a client, and controls the MPU to activate the host charging device to charge a connected client charging device.

2. The charging device as claimed in claim 1, wherein the control module includes a host controller and a client controller, the host controller controls the power storage module to charge via the charging and discharging module, and the client controller controls the power storage module to discharge via the charging and discharging module.

3. The charging device as claimed in claim 1, wherein the interface module includes a USB interface for connecting to another charging device, a USB transceiver for sending data, and a detecting module for detecting the host charging device and the client charging device.

4. The charging device as claimed in claim 3, wherein the USB interface includes a V_{BUS} pin for inputting/outputting power, a ID pin for confirming the charging device is a host or a client, a D+ pin and a D− pin for sending data, and a GND pin connected to a ground.

5. The charging device as claimed in claim 1, further comprising a connecting device one end of the connecting device is connected to the USB interface of the host charging device, another end of the connecting device is connected to the USB interface of the client charging devices.

6. A charging method, comprising:
providing at least two charging devices mounted in different portable electronic devices;
establishing a connection among the charging devices;
confirming the host charging device and the client charging device; and
the host charging device charges the client charging device.

7. The charging method as claimed in claim 6, further comprising setting a host charging device and at least one client charging device after establishing a connection among the charging devices.

8. The charging method as claimed in claim 6, further comprising the client charging device sending the ID signals to the host charging device before confirming the host charging devices and the client charging device.

9. The charging method as claimed in claim 6, further comprising: connecting the charging devices directly to each other when the number of the charging devices is two.

10. The charging method as claimed in claim 6, further comprising: connecting the charging devices via a connecting device when there are more than two charging devices.
